(19) United States
(12) Patent Application Publication
(10) Pub. No.: US 2007/0192080 A1
(43) Pub. Date: Aug. 16, 2007

(54) Data tree structure for automatic retention of context information

(76) Inventors: Bryan F. Carpenter, Loveland, CO (US); Carli Connally, Fort Collins, CO (US); Reid Hayhow, LaPorte, CO (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/345,042

(22) Filed: Jan. 31, 2006

(51) Int. Cl. G06F 9/45

(52) U.S. Cl. 703/22

(57) ABSTRACT

In an embodiment, there is disclosed a system for processing test data, including a data populator having code for: (1) generating data objects from test data, (2) arranging data objects in a tree structure, and (3) generating tokens referring to data objects; code for releasing data objects for reclamation of memory for data objects having no references thereto, and clients having code for: (1) receiving tokens generated by the data populator, (2) reading data objects referred to by tokens, and (3) deleting tokens after reading data objects. In an embodiment, a method of processing data objects from test data is disclosed, including generating data objects from test data; arranging data objects in a tree structure; generating tokens referring to data objects; and reclaiming memory storing data objects having no references from tokens or child data objects. Other embodiments are also disclosed.

### BACKGROUND

Generally, test data for a device under test is processed immediately upon receipt into a data formatting system. The test data may be received as a series of events that logically form a hierarchy. In order to fully understand and interpret a particular event, it is often necessary to have access to information related to other events so as to provide necessary context.

With a single data formatter, processing the test data in the data formatting system is relatively straightforward and does not require complicated memory management techniques. However, for other data processing scenarios, complex memory management may involve explicit code to free data model object at appropriate times. Such complex techniques are often a fertile environment for errors and memory “leaks”.

### SUMMARY OF THE INVENTION

In an embodiment, there is provided a system for processing test data, the system comprising a data populator having code for: (1) generating data objects from the test data, (2) arranging the data objects in a tree structure, and (3) generating tokens referring to at least one of the data objects; a data model in communication with the data populator, and the data model selectively storing the data objects having references from at least one selected from the group consisting of the tokens and child data objects, and code for releasing data objects selectively stored in the data model for reclamation of memory for data objects having no references from at least one selected from the group consisting of the tokens and child data objects in the tree structure; and a plurality of clients in communication with the data model, the clients having code for: (1) receiving the tokens generated by the data populator, (2) reading the data objects referred to by the tokens, and (3) deleting the tokens together with corresponding references to the data objects after reading the data objects.

In another embodiment, there is provided a system for processing data objects from test data, the system comprising a data populator having code for: (1) generating data objects from the test data, (2) arranging the data objects in a relational structure relative to one another, wherein child objects have references to parent objects, (3) generating tokens having references to the data objects; code for reclamation of memory storing the data objects having no references from at least one selected from the group consisting of the tokens and child data objects in the relational structure; and a plurality of clients in communication with the data populator, wherein the clients each selectively obtain tokens having references to the data objects and read the data objects referred to by the tokens.

In yet another embodiment, there is provided a method of processing data objects from test data, the method comprising generating data objects from the test data; arranging the data objects in a tree structure, wherein child objects have references to parent objects; generating tokens referring to at least one of the data objects; and reclaiming memory storing the data objects having no references from at least one selected from the group consisting of the tokens and the child data objects in the tree structure.

In still another embodiment, there is provided a method of processing test data, the method comprising generating data objects from the test data; arranging the data objects in a tree structure; generating tokens referring to at least one of the data objects; selectively storing the data objects having references from at least one selected from the group consisting of the tokens and child data objects; transferring the tokens generated from the test data to clients; reading the data objects referred to by the tokens with the clients; deleting the tokens together with corresponding references to the data objects after reading the data objects; and reclaiming memory storing the data objects having no references from at least one selected from the group consisting of the tokens and child data objects in the tree structure.

Other embodiments are also disclosed.

### BRIEF DESCRIPTION OF THE DRAWINGS

Illustrative embodiments of the invention are illustrated in the drawings, in which:

FIG. 1 illustrates a schematic diagram of a system for processing data objects from test data;

FIG. 2 illustrates a schematic diagram of a data model having tokens pointing to child objects within a system for processing data objects from test data;

FIG. 3 illustrates a schematic diagram of a data model having tokens pointing to child objects and parent objects within a system for processing data objects from test data;

FIG. 4 illustrates a flow chart diagram of a method of processing data objects from test data;

FIG. 5 illustrates a flow chart diagram of a method of processing data objects from test data; and

FIG. 6 illustrates a flow chart diagram of a method of processing data objects from test data.

### DETAILED DESCRIPTION OF AN EMBODIMENT

Test data which is not processed immediately upon receipt of the data requires storage in memory. For single formatters, no storage is typically required as data is processed as it is received. However, for multiple independent formatters, data storage is generally required.

It is usually desirable to maintain the availability of test data as context information until the formatters do not require the information. As the continuous data logging process may involve large volumes of data over time, there is usually not enough memory to hold all of the information. Therefore, it can be highly desirable to discard items as soon as the possibility for use has passed.

As provided herein, the structure of the objects formed from the test data stored in the data model facilitates the operation of multiple data formatters at independent rates. Each of the formatters consumes needed data at its own pace. This may provide good performance and flexibility in operation of data formatting system.

A potentially complex memory management situation may be handled automatically with a clean dependency structure. This structure avoids the need for explicit code to deal with freeing data model objects at the appropriate time. Such explicit code for freeing data model objects may induce errors and memory leaks.

Counted references or pointers are used with each object to provide an associated count of the total number of other objects holding references thereto. When the number of other objects referring to a particular object decreases to zero, the object is automatically deleted from memory. In turn, this memory may be reclaimed for reuse.

Each item, including parent objects, child objects and tokens, in the hierarchy or structure holds a reference to its parent. This reference causes the parent object to be retained in memory. As an object's parent, grandparent, or higher level parent may provide needed context, each of these high level parents are held in memory as long as there is potential for access for information content.

Reference-counted memory retention works as the child objects hold references to the parent objects. If the parent objects were to hold references to their children, the parents and the children would never be deleted from memory because each would be held in place by the other. Accordingly, parents do not keep references to their children.

A client that holds a token referring to a child objects has access to all of the context data from the parent and other higher level parent objects. Furthermore, these parent objects, grandparent objects and other higher level objects are maintained until the token referring to the parent object is deleted.

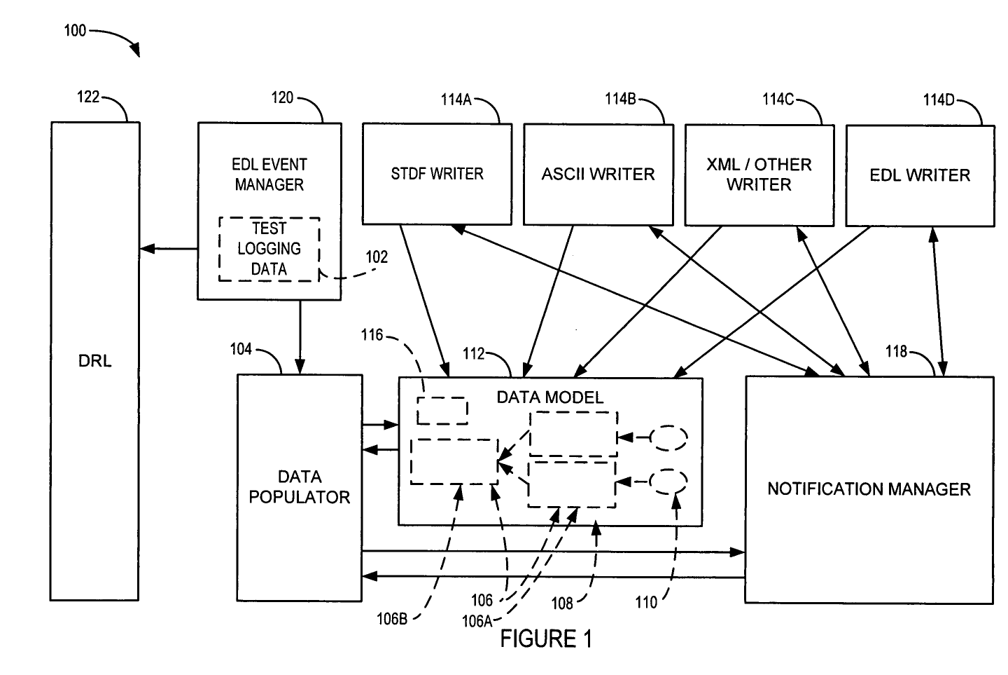

Referring to FIG. 1, there is shown a system 100 for processing test data 102. In an embodiment, system 100 may include a data populator 104 having code for: (1) generating data objects 106 from test data 102, (2) arranging data objects 106 in a tree structure 108, and (3) generating tokens 110 referring to at least one of data objects 106.

In an embodiment, a data model 112 is in communication with data populator 104. Data model 112 may selectively store data objects 106 having references from at least one selected from the group consisting of tokens 110 and child data objects 106A.

A plurality of clients 114A-114D are shown in communication with data model 112. Clients 114A-114D may have code for: (1) receiving tokens 110 generated by data populator 104, (2) reading data objects 106 referred to by tokens 110, and (3) deleting tokens 110 together with corresponding references to data objects 106 after reading data objects 106. In an embodiment, there is provided code for releasing data objects 106 selectively stored in data model 112 for reclamation of memory for data objects 106 having no references from at least one selected from the group consisting of the tokens 110 and child data objects 106A in tree structure 108.

In one embodiment, each one of tokens 110 refers to one selected from the group consisting of child data object 106A and a parent data object 106B.

In an embodiment, at least one child data object 106A refers to a parent data object 106B.

In one embodiment, each one of child data objects 106A has one of the tokens 110 referring thereto.

Each one of the child data objects 106A has one of the tokens 110 referring thereto. Each one of the child objects 106A refers to a parent data object 106B. Clients 114A-114D may read each one of the child data objects 106A referred to by tokens 110 and may read each one of the parent data objects 106B referred to by the child data objects 106A.

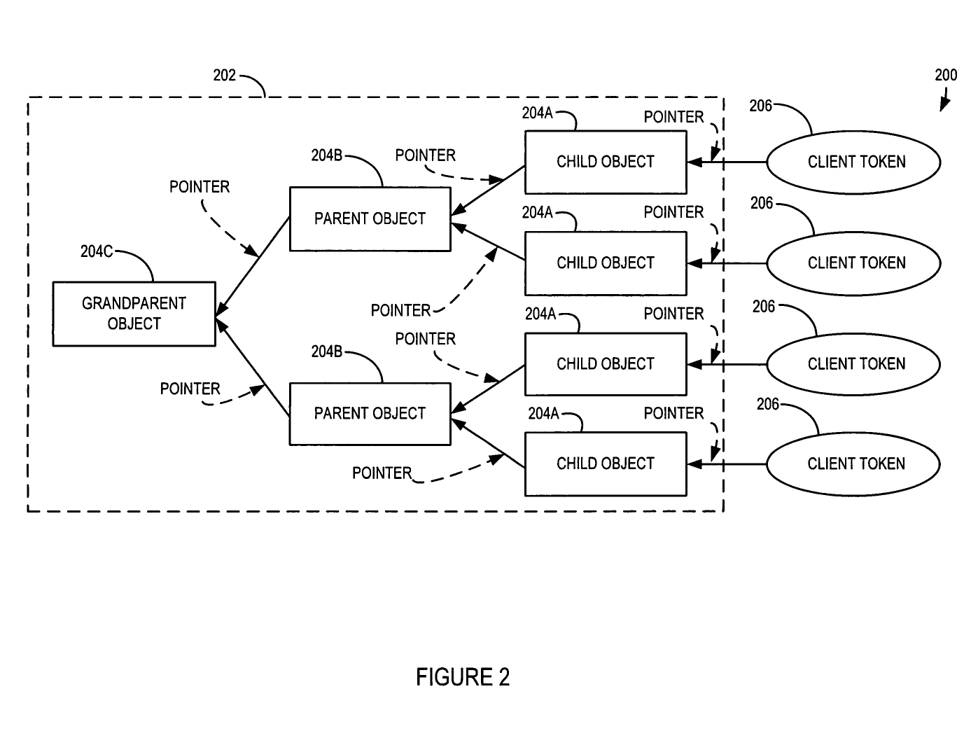

Looking at FIG. 2, there is shown a portion of a system 200, which relates to system 100, and includes a data model 202 having child objects 204A, parent objects 204B, and a grandparent object 204C. These objects are arranged in a structure with pointers from child objects 204A to parent objects 204B, and with pointers from parent objects 204B to grandparent object 204C. Although not shown, additional levels of parent objects may be formed above grandparent object 204C, additional levels of child objects may be formed below child objects 204A, and different numbers of objects may be formed within any one of the levels of child objects 204A, parent objects 204B, and grandparent object 204C depending on the test data.

Referring still to FIG. 2, and in an embodiment, there are shown client tokens 206 having pointers to child objects 204A. Each object 204A, 204B and each token 206 in the structure within data model 202 holds a reference to its parent. This reference, which is also referred to as a pointer, causes retention of objects 204A, 204B, 204C in memory. As an object's parent, grandparent, or higher level parent may provide needed context, each of these high level parents are held in memory as long as there is potential for access for information content.

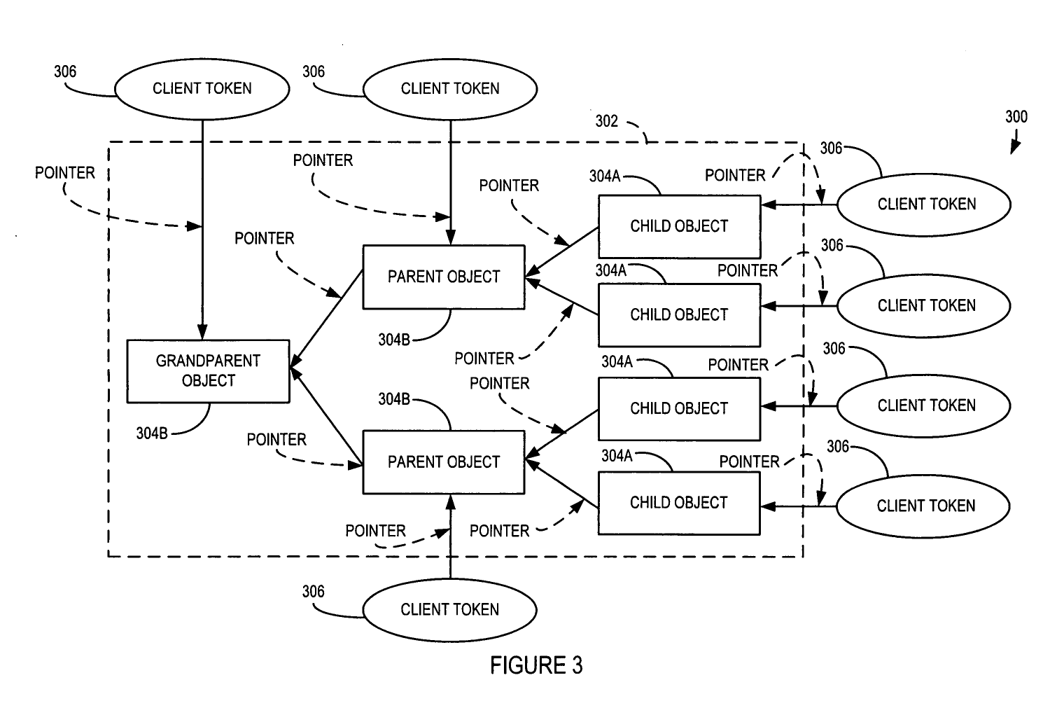

Looking at FIG. 3, there is shown a portion of a system 300, which relates to system 100, and includes a data model 302 having child objects 304A, parent objects 304B, and a grandparent object 304C. These objects are arranged in a structure with pointers from child objects 304A to parent objects 304B, and with pointers from parent objects 304B to grandparent object 304C. Although not shown, additional levels of parent objects may be formed above grandparent object 304C, additional levels of child objects may be formed below child objects 304A, different numbers of objects may be formed within any one of the levels of child objects 304A, parent objects 304B, and grandparent object 304C depending on the test data.

Referring still to FIG. 3, and in an embodiment, there are shown client tokens 306 having pointers to child objects 304A, parent objects 304B, and grandparent object 304C. Each object 304A, 304B and each token 306 in the structure within data model 302 holds a reference to its parent. This reference, which is also referred to as a pointer, causes retention of the object 304A, 304B, 304C in memory. As each one of the objects 304A, 304B, 304C have a reference from at least one token 306, each one of the objects 304A, 304B, 304C will not be deleted until each one of child objects and tokens referring thereto are deleted.

Referring to FIG. 1, in an embodiment, code may be provided for monitoring a count 116 of references to each one of the data objects 106 from child data objects 106A and from tokens 110.

In an embodiment, code of data populator 104 may calculate count 116 of references to each one of data objects 106. Count 116 of the references decrements for each deletion of one of child data objects 106A and for each deletion of one of tokens 110. In one embodiment, code for releasing memory storing data objects 106A of data populator 104 allows reclamation of memory storing each of data objects 106 when count 116 of references related thereto decrements to zero.

In an embodiment, the plurality of clients 114A-114D include data formatters. The data formatters may include at least one chosen from the group consisting of an STDF (Standard Test Definition Format) writer, an ASCII (American Standard Code for Information Interchange) writer, an XML (extensible markup Language) writer or another type of formatter chosen in the future, and an EDL (Event Data Logging) writer.

Referring still to FIG. 1, and in one embodiment, a notification manager 118 is in communication with data populator 104 and clients 114A-114D. Notification manager notifies clients 114A-114D of data objects 106 and tokens 110 generated by data populator 104. Clients 114A-114D each selectively read data objects 106 stored in data model 112 based on the references from tokens 110.

In an embodiment, there is provided a system 100 for processing data objects 106 from test data 102. System 100 may include data populator 104 having code for generating data objects 106 from test data 102. Data populator 104 may include code for arranging data objects 106 in a relational structure 108, which may include but is not limited to a tree structure 108, relative to one another. Child objects 106A may have references to parent objects 106B. Data populator 104 may include code for generating tokens 110 having references to data objects 106. System 100 may have code for reclamation of memory storing data objects 106 having no references from at least one selected from the group consisting of tokens 110 and child data objects 106A in the relational structure 108. System 100 may include a plurality of clients 114A-114D in communication with data populator 104. Clients 114A-114D may each selectively obtain tokens 110 having references to data objects 106 and read data objects 106 referred to by tokens 110.

In one embodiment, an EDL event manager 120 may provide test data 102 to data populator 104. EDL event manager 120 may receive test data 102 from a DRL 122.

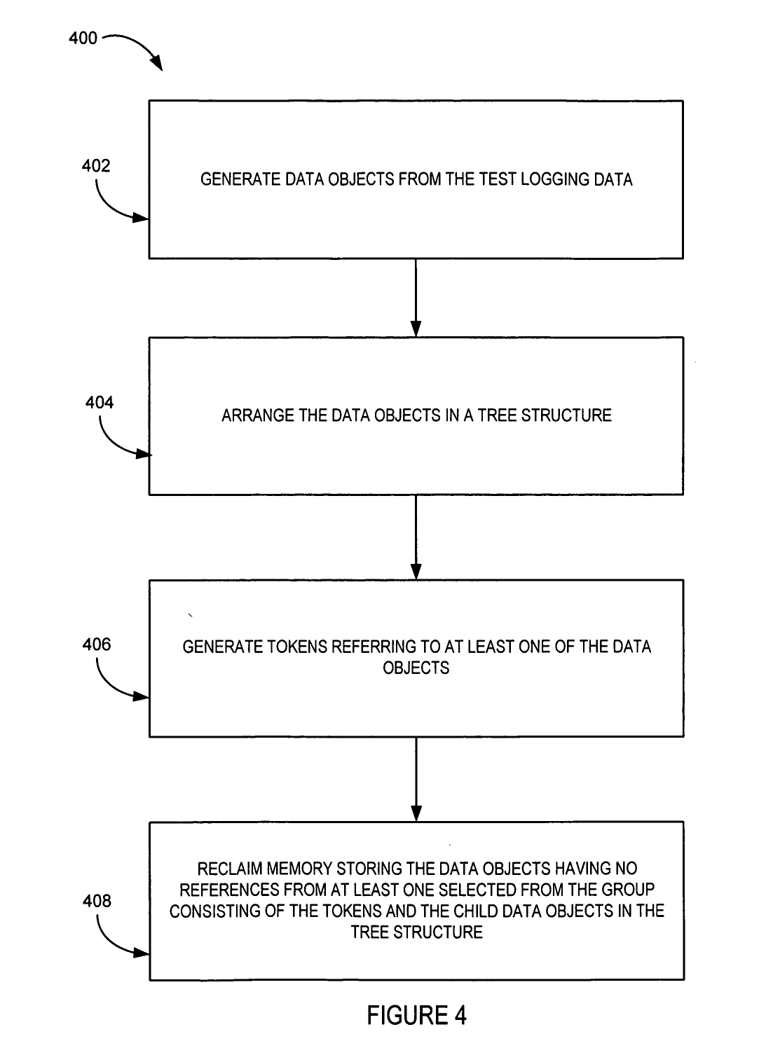

Referring to FIG. 4, there is shown a method 400 of processing data objects from test data. In an embodiment, method 400 may include the step of generating 402 data objects from the test data. Method 400 may include the step of arranging 404 the data objects in a tree structure, wherein child objects have references to parent objects. In addition, method 400 may include generating 406 tokens referring to at least one of the data objects. Finally, method 400 may include reclaiming 408 memory storing the data objects having no references from at least one selected from the group consisting of the tokens and the child data objects in the tree structure.

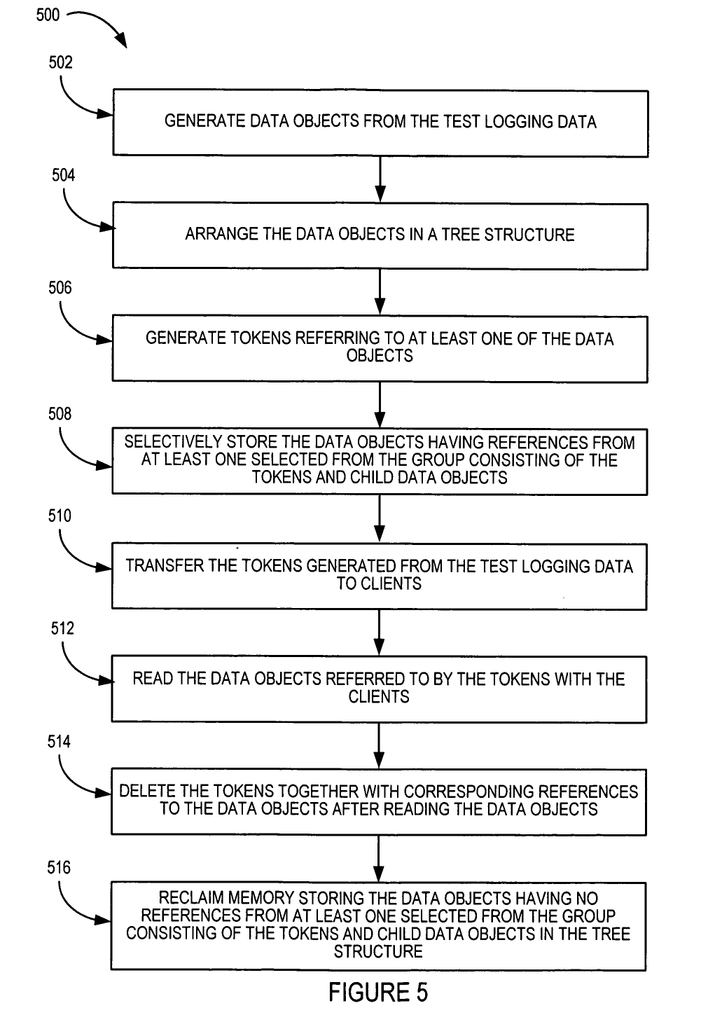

Referring to FIG. 5, there is shown a method 500 of processing test data. In an embodiment, method 500 includes the step of generating 502 data objects from the test data. Method 500 may include arranging 504 the data objects in a tree structure. Furthermore, method 500 includes generating 506 tokens referring to at least one of the data objects. Method 500 may include selectively 508 storing the data objects having references from at least one selected from the group consisting of the tokens and child data objects. Method 500 includes transferring 510 the tokens generated from the test data to clients. Next, method 500 includes reading 512 the data objects referred to by the tokens with the clients. Method 500 may include deleting 514 the tokens together with corresponding references to the data objects after reading the data objects. Method 500 includes reclaiming 516 memory storing the data objects having no references from at least one selected from the group consisting of the tokens and child data objects in the tree structure.

In one embodiment, the step of generating 502 data objects from the test data may occur within a data populator. In an embodiment, the step of arranging 504 the data objects in the tree structure forms parent objects and child objects. Each one of the child objects may refer to one of the parent objects. Generally, the step of generating 506 the tokens includes, but is not limited to, generating the tokens referring to each one of the child objects. Furthermore, the step of generating 506 the tokens may include generating tokens referring to at least one of the parent objects.

In an embodiment, the step of selectively storing 508 the data objects may include storing the data objects in a data model.

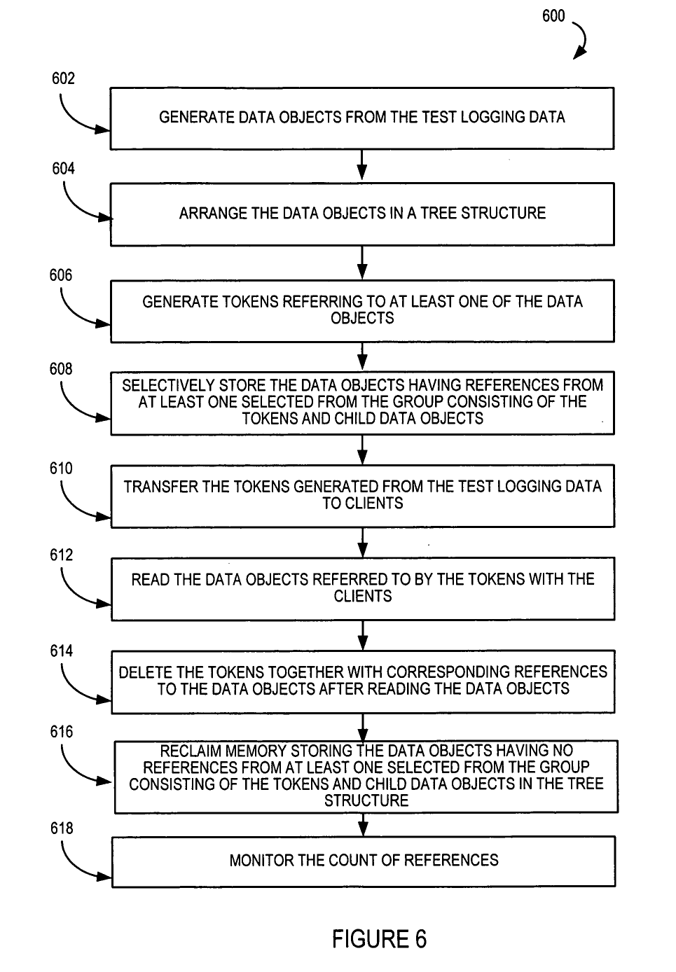

Referring to FIG. 6, and in one embodiment, there is shown a method 600 of processing test data. In an embodiment, method 600 includes the step of generating 602 data objects from the test data. Method 600 may include arranging 604 the data objects in a tree structure. Furthermore, method 500 includes generating 606 tokens referring to at least one of the data objects. Method 600 may include selectively 608 storing the data objects having references from at least one selected from the group consisting of the tokens and child data objects. Method 600 includes transferring 610 the tokens generated from the test data to clients. Next, method 600 includes reading 612 the data objects referred to by the tokens with the clients. Method 600 may include deleting 614 the tokens together with corresponding references to the data objects after reading the data objects. Method 600 includes reclaiming 616 memory storing the data objects having no references from at least one selected from the group consisting of the tokens and child data objects in the tree structure. Optionally, the step of deleting 516 the data objects may include monitoring 518 a count of references to each one of the data objects.

In an embodiment, the step of monitoring 618 the count of references may include decrementing the count for each one of the data objects in response to the deletion of each one of the tokens referring thereto and the deletion of each one of the child objects the child objects referring thereto.

For method 500 or method 600, the step of reclaiming 516, 616 memory storing the data objects having no references may occur when the count of references related thereto decrements to zero.

What is claimed is:

1. A system for processing test data, the system comprising:
a data populator having code for: (1) generating data objects from the test data, (2) arranging the data objects in a tree structure, and (3) generating tokens referring to at least one of the data objects;
a data model in communication with the data populator, and the data model selectively storing the data objects having references from at least one selected from the group consisting of the tokens and child data objects, and code for releasing data objects selectively stored in the data model for reclamation of memory for data objects having no references from at least one selected from the group consisting of the tokens and child data objects in the tree structure; and
a plurality of clients in communication with the data model, the clients having code for: (1) receiving the tokens generated by the data populator, (2) reading the data objects referred to by the tokens, and (3) deleting the tokens together with corresponding references to the data objects after reading the data objects.

2. A system in accordance with claim 1, wherein each one of the tokens refers to one selected from the group consisting of a child data object and a parent data object.

3. A system in accordance with claim 1, wherein at least one child data object refers to a parent data object.

4. A system in accordance with claim 1, wherein each one of the child data objects has one of the tokens referring thereto.

5. A system in accordance with claim 1, wherein each one of the child data objects has one of the tokens referring thereto, wherein each one of the child objects refers to a parent data object, and wherein the clients read each one of the child data objects referred to by the tokens and read each one of the parent data objects referred to by the child data objects.

6. A system in accordance with claim 1, wherein code is provided for monitoring a count of references to each one of the data objects from the child data objects and from the tokens.

7. A system in accordance with claim 6, wherein the code calculates the count of references to each one of the data objects, and wherein the count of references decrements for each deletion of one of the child data objects and for each deletion of one of the tokens.

8. A system in accordance with claim 7, wherein the code for releasing the data objects of the data populator allows reclamation of memory storing each of the data objects when the count of references related thereto decrements to zero.

9. A system in accordance with claim 1, wherein the plurality of clients include data formatters.

10. A system in accordance with claim 9, wherein the data formatters include at least one chosen from the group consisting of an STDF writer, an ASCII writer, an XML writer, and an EDL writer.

11. A system in accordance with claim 1, wherein a notification manager is in communication with the data populator and the clients, wherein the notification manager notifies the clients of the data objects and the tokens generated by the data populator, and wherein the clients each selectively read the data objects stored in the data model based on the references from the tokens.

12. A system for processing data objects from test data, the system comprising:
a data populator having code for: (1) generating data objects from the test data, (2) arranging the data objects in a relational structure relative to one another, wherein child objects have references to parent objects, (3) generating tokens having references to the data objects;
code for reclamation of memory storing the data objects having no references from at least one selected from the group consisting of the tokens and child data objects in the relational structure; and
a plurality of clients in communication with the data populator, wherein the clients each selectively obtain tokens having references to the data objects and read the data objects referred to by the tokens.

13. A method of processing data objects from test data, the method comprising:
generating data objects from the test data;
arranging the data objects in a tree structure, wherein child objects have references to parent objects;
generating tokens referring to at least one of the data objects; and
reclaiming memory storing the data objects having no references from at least one selected from the group consisting of the tokens and the child data objects in the tree structure.

14. A method of processing test data, the method comprising:
generating data objects from the test data;
arranging the data objects in a tree structure;
generating tokens referring to at least one of the data objects;
selectively storing the data objects having references from at least one selected from the group consisting of the tokens and child data objects;
transferring the tokens generated from the test data to clients;
reading the data objects referred to by the tokens with the clients;
deleting the tokens together with corresponding references to the data objects after reading the data objects; and
reclaiming memory storing the data objects having no references from at least one selected from the group consisting of the tokens and child data objects in the tree structure.

15. A method in accordance with claim 14, wherein generating data objects from the test data occurs within a data populator.

16. A method in accordance with claim 14, wherein arranging the data objects in the tree structure forms parent objects and child objects, wherein each one of the child objects refers to one of the parent objects.

17. A method in accordance with claim 16, wherein generating the tokens comprises generating the tokens referring to each one of the child objects.

18. A method in accordance with claim 17, wherein generating the tokens comprises generating the tokens referring to at least one of the parent objects.

19. A method in accordance with claim 14, wherein selectively storing the data objects comprises storing the data objects in a data model.

20. A method in accordance with claim 14, wherein deleting the data objects comprises monitoring a count of references to each one of the data objects.

21. A method in accordance with claim 20, wherein monitoring the count of references comprises decrementing the count for each one of the data objects in response to the deletion of each one of the tokens referring thereto and the deletion of each one of the child objects the child objects referring thereto.

22. A method in accordance with claim 21, wherein reclaiming memory storing the data objects having no references occurs when the count of references related thereto decrements to zero.
